(19) United States
(12) Patent Application Publication
(10) Pub. No.: US 2008/0079873 A1
(43) Pub. Date: Apr. 3, 2008

(54) ACTIVE MATRIX TYPE LIQUID CRYSTAL DISPLAY APPARATUS WITH HIGH TRANSMITTED COLOR FILTERS

(76) Inventors: YUKA UTSUMI, Hitachi (JP); Kazumi Kanesaka, Chonan (JP); Hiroshi Obata, Chiba (JP); Kikuo Ono, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/836,880

(22) Filed: Aug. 10, 2007

(30) Foreign Application Priority Data
Sep. 29, 2006 (JP) 2006-266249

(51) Int. Cl. G02F 1/1335

(52) U.S. Cl. 349/106

(57) ABSTRACT

A liquid crystal display apparatus has: a pair of substrates; a pair of alignment plates disposed on the pair of substrates; a liquid crystal layer confined between the pair of substrates; an electrode group formed at least one of the pair of substrates, the electrode group applying an electric field to the liquid crystal layer; color filters formed on one of the pair of substrates; and a light source unit disposed on a back of the other of the pair of substrates, wherein the color filters include at least blue, green and red color filters, and wavelengths providing halves of a maximum transmittance of the green color filter are between from 590 nm to 610 n on one side, and between from 470 nm to 500 nm on the other side.

### BACKGROUND OF THE INVENTION

The present invention relates to a liquid crystal display panel and a liquid crystal display apparatus respectively having a high transmittance, a high contrast and an excellent display performance.

Application fields and markets of a liquid crystal display have expanded because of its advantage that the liquid crystal display can be made thinner and lighter than a cathode ray tube (CRT; generally called a Braun tube) which was the main current of display apparatus and because of its improved image quality.

With recent expansion of the application fields to monitors of desk top type personal computers, to monitors for printing and design, and to liquid crystal televisions, requests for good color reproduction and a high contrast ratio are increasing. The spread of liquid crystal televisions has been promoted particularly by digital TV broadcasting and high definition TV broadcasting. Although a liquid crystal television has the advantage of good image quality, it is considered very important to improve color reproduction and a contrast ratio. Various technologies for improving the color reproduction and contrast ratio have been developed. Improving the color reproduction and contrast ratio and expanding the color reproduction is, however, associated always with a reduction in a transmittance of a liquid crystal display panel and an increase in a consumption power. This is because coloring of a liquid crystal display is based on three primary colors of blue, green and red. Namely, improving color reproduction means improving the croma of each primary color, and this means a reduction in a wavelength width allowing transmission of light in coloring with three primary colors. This is nothing less than an increase in a ratio of light not used in coloring. Namely, since an energy of light discarded and not used in coloring increases, a light usage efficiency of a liquid crystal display panel lowers.

Technologies of realizing both the improvement on color reproduction and the increase in a light usage efficiency of a liquid crystal display panel are reported, for example, in JP-A-2005-234133 and S. Roth et al., SID Digest '03, 118 (2003). Both technologies do not use three primary colors as reference colors, but use four or five primary colors by adding at least one or more complementary colors of yellow, cyan and magenta, to three primary colors.

### SUMMARY OF THE INVENTION

Coloring with multi primary colors disclosed in JP-A-2005-234133 and S. Roth et al., SID Digest '03, 118 (2003) is effective in terms of spectroscopy in that light from a visual wavelength of 400 to 700 nm is used sufficiently. However, if one pixel unit is constituted of dots more than three dots of blue, green and red, the number of wiring electrodes for driving dots increases. This is nothing less than an increase in a non-display area (it is necessary to provide optical shielding by a black matrix or the like to prevent optical leak). Namely, from the viewpoint of an area, there is a contradiction that a light usage efficiency is lowered.

The present inventors have made the present invention by vigorously studying devices capable of spectroscopically increasing a light usage efficiency without reducing a display area and without degrading color reproduction.

The present inventors have made the present invention by incorporating an approach to spatial separation and functional separation of a wavelength in order to overcome the technical contradiction between a transmission efficiency and a color purity.

According to the invention, it is possible to improve both the color reproduction and the light usage efficiency of a liquid crystal display apparatus for coloring with three primary colors of blue, green and red, by controlling spectroscopy of a green color filter for displaying a wavelength region having the highest spectral luminous efficacy.

A specific configuration achieving the object of the present invention is, for example, the following spectral transmittance characteristics. A green color filter has a wavelength range from 530 to 560 nm providing the maximum transmittance, has the absolute maximum transmittance of at least 80%, and has the wavelengths (half value wavelengths) providing a transmittance half the maximum transmittance, one being in a range from 590 to 600 nm and the other being in a range from 480 to 490 nm.

Alternatively, a green color filter has a wavelength range from 530 to 560 nm providing the maximum transmittance, and a transmittance at a wavelength of 600 nm is 40% or more of the maximum transmittance.

As shown in FIG. 18, the spectral luminous efficacy of human being has a peak at a wavelength of 555 nm. When considering this fact, it is obvious that improving the transmittance near at this wavelength is most effective for improving a transmission efficiency of a liquid crystal display panel. However, coloring of the liquid crystal display panel generally uses additive mixture of three primary colors of blue, green and red. Therefore, it is essential to retain a high color purity of coloring of each primary color in order to display a number of colors. This does not mean therefore to increase at hazard the transmittance in the wavelength range having a high luminous efficacy. There is a tradeoff between a transmittance and a color purity of spectroscopy of color filters in charge of coloring with three primary colors. If prominence is given to the color purity, the transmittance lowers, whereas if prominence is given to the transmittance, the color purity lowers. Generally, the former is used for the design of monitors for professionals handling televisions and images, and the latter is used for the design of monitors for apparatus such as note PC's which are essential to reduce a consumption power.

Improving the transmission efficiency of a liquid crystal display panel is an important issue regarding improvement on the image quality or reduction in a consumption power. The improvement on the transmission efficiency of a liquid crystal display panel can reduce a luminance of a light source necessary for displaying the maximum luminance of a liquid crystal television and a liquid crystal display monitor, resulting in a reduction in a consumption power. The reduction in the consumption power is an important issue from the viewpoint of preventing global warming.

The present inventors have studied to maximize a transmission efficiency of a liquid crystal display panel and to retain a green color purity. The present inventors have found the above-described spectral transmittance characteristics of green. A change in green chromaticity is in a detectable range of human visual perception, and the transmittance can be improved by about 10%.

The present inventors have also studied a back light to be adopted for effectively utilizing the improvement on the transmittance of a liquid crystal display panel. It has been found that the image quality performance can be improved further by setting an emission wavelength of red phosphor near 620 nm instead of a conventional wavelength near 611 nm.

It is possible to realize a liquid crystal display panel having a high transmittance with an increased light usage efficiency and to provide a liquid crystal display apparatus excellent in reproductivity and rendering of colors and images.

Other objects, features and advantages of the invention will become apparent from the following description of the embodiments of the invention taken in conjunction with the accompanying drawings.

### BRIEF DESCRIPTION OF THE DRAWINGS

FIG. 1 is a graph (represented by wavelength/transmittance) showing the spectral transmittance characteristics of color filters according to a first embodiment.

FIG. 2 shows a schematic cross sectional view showing a region near a dot of a liquid crystal display apparatus according to the first embodiment of the present invention, and a schematic diagram of a back light unit of the liquid crystal display apparatus (a light source and an inverter are not shown).

FIG. 3 is a schematic cross sectional view showing the structure of a thin film transistor of an active matrix substrate of the liquid crystal display apparatus according to the first embodiment of the present invention.

FIG. 4 is a schematic diagram showing an area near a dot of the active matrix substrate of the liquid crystal display apparatus according to the first embodiment of the present invention.

FIG. 5 is a schematic diagram showing an area near one pixel constituted of blue, green and red of a color filter substrate of the liquid crystal display apparatus according to the first embodiment of the present invention.

FIG. 6 is a graph (represented by wavelength/transmittance) showing the spectral transmittance characteristics of white display of a liquid crystal display panel of the first embodiment and of a liquid crystal display panel of a first comparative example.

FIG. 7 shows chromaticity distribution coordinates of blue, green and red relative to a standard light source C of the liquid crystal display panel of the first embodiment and of the liquid crystal display panel of the first comparative example.

FIG. 8 is a graph (represented by wavelength/spectral emission luminance) showing the emission spectrum of a back light unit of a second embodiment.

FIG. 9 shows chromaticity distribution coordinates of blue, green and red relative to a standard light source C of a liquid crystal display module of the second embodiment and of a liquid crystal display module of a second comparative example.

FIG. 10 is a graph (represented by wavelength/spectral emission luminance) showing the emission spectrum of a back light unit of a third embodiment.

FIG. 11 shows chromaticity distribution coordinates of blue, green and red relative to a standard light source C of a liquid crystal display module of the third embodiment and of the liquid crystal display module of the second comparative example.

FIG. 12 is a graph (represented by wavelength/transmittance) showing the spectral transmittance characteristics of color filters according to a fourth embodiment.

FIG. 13 shows chromaticity distribution coordinates of blue, green and red relative to a standard light source C of a liquid crystal display panel of the fourth embodiment and of the liquid crystal display panel of the first comparative example.

FIG. 14 shows chromaticity distribution coordinates of blue, green and red relative to a standard light source C of a liquid crystal display module of a fifth embodiment and of the liquid crystal display module of the second comparative example.

FIG. 15 shows chromaticity distribution coordinates of blue, green and red relative to a standard light source C of a liquid crystal display module of a sixth embodiment and of the liquid crystal display module of the second comparative example.

FIG. 16 is a schematic cross sectional view showing an area near one pixel constituted of blue, green and red of a liquid crystal display apparatus according an embodiment of the present invention.

FIG. 17 shows an example of chromaticity of blue, green and red of a liquid crystal display module of the present invention and of a liquid crystal display module of a comparative example.

FIG. 18 is a diagram showing a spectral luminous efficacy of human being.

### DETAILED DESCRIPTION OF THE EMBODIMENTS

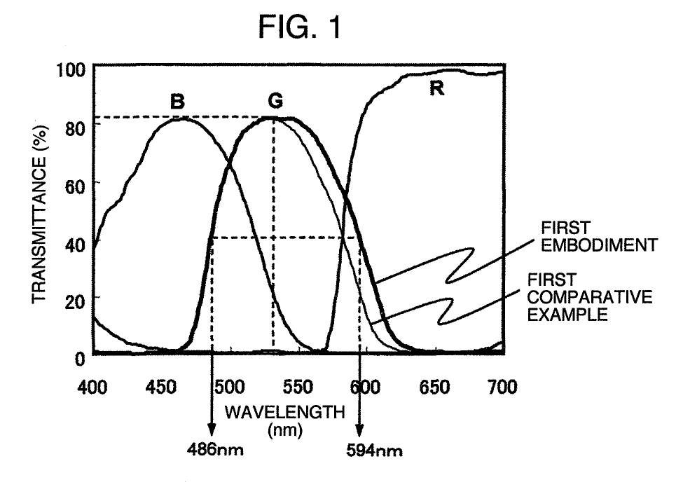

Next, with reference to FIGS. 1 to 18, description will be made on a liquid crystal display apparatus according to embodiments of the present invention. The present invention is not limited only to the following embodiments.

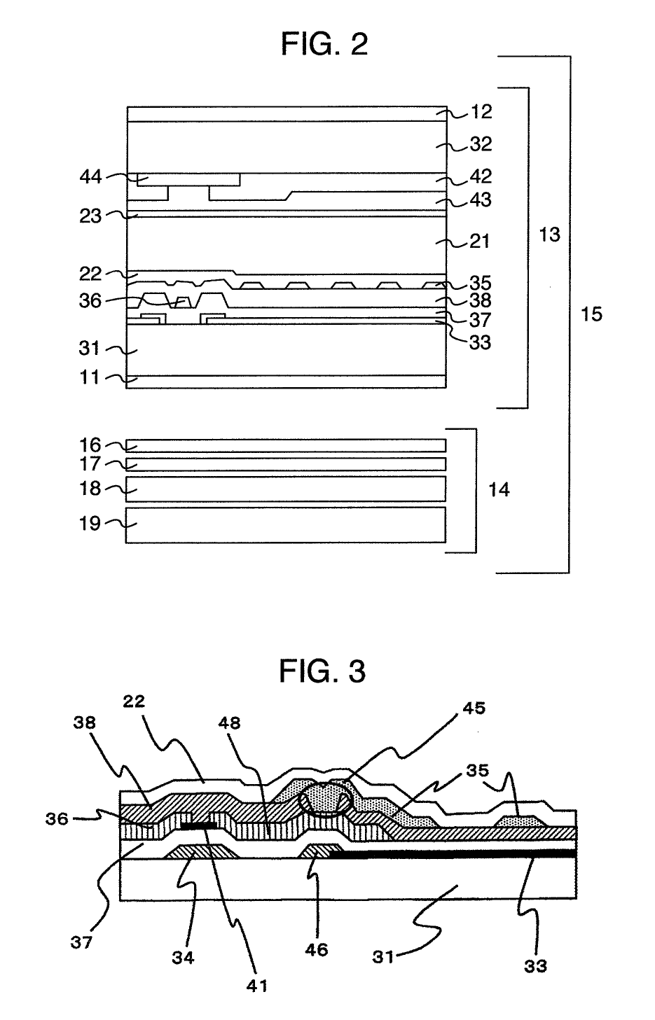

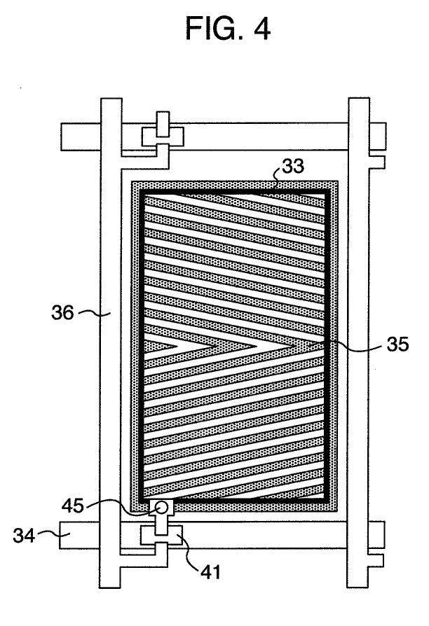

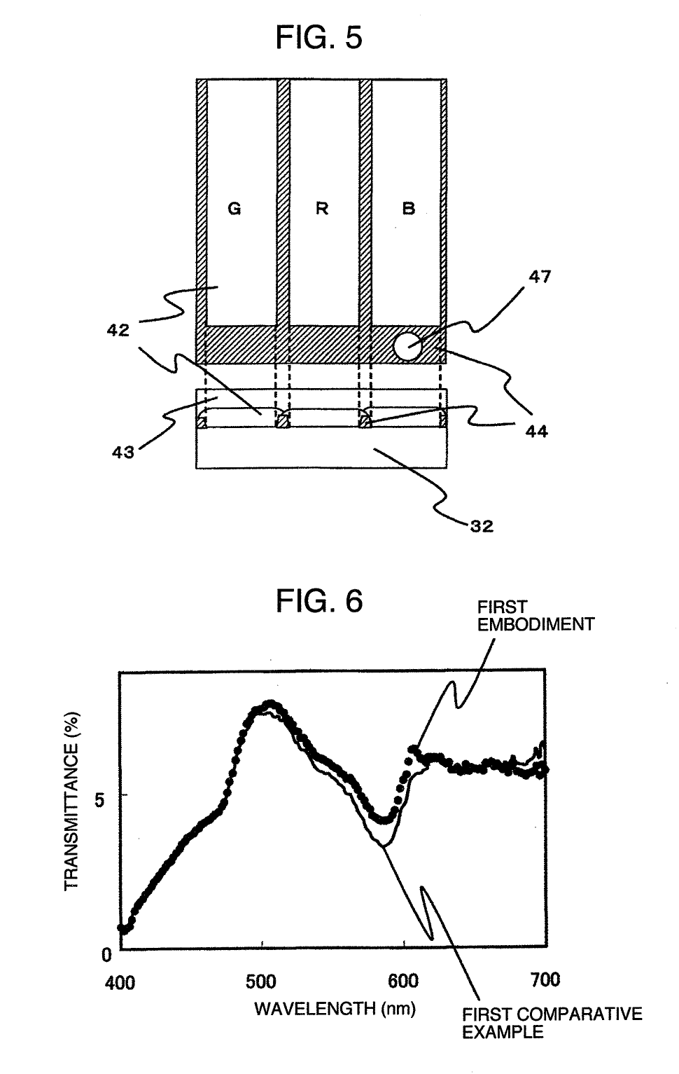

With reference to FIGS. 2 to 5, description will be made on manufacture of a liquid crystal display apparatus according to the first embodiment of the present invention. FIGS. 2 and 3 are schematic cross sectional views showing the region near one dot of the liquid crystal display apparatus according to the first embodiment of the present invention. FIG. 4 is a schematic diagram showing the structure of an area near one dot of an active matrix substrate of the liquid crystal display apparatus according to the first embodiment of the present invention, and FIG. 5 is a schematic diagram showing an area near one pixel (a unit constituted of blue, green and red dots) of a color filter substrate.

As shown in FIGS. 2 to 4, on a glass substrate 31 as an active matrix substrate, a common electrode 33 made of indium-tin-oxide (ITO) is disposed, and a scan electrode (gate electrode) 34 and a common electrode wiring (common wiring) 46 respectively made of molybdenum/aluminum (Mo/Al) are formed being superposed upon the ITO common electrode. A gate insulating film 37 made of silicon nitride is formed covering the common electrode 33, gate electrode 34 and common electrode wiring 46. A semiconductor film 41 made of amorphous silicon or polysilicon is formed on the gate insulating film 37 and above the scan electrode 34. The semiconductor film functions as an active layer of a thin film transistor (TFT) of an active element. A signal electrode (drain electrode) 36 and a dot electrode (source electrode) wiring 48 respectively made of chrome/molybdenum (Cr/Mo) are formed partially being superposed upon the pattern of the semiconductor film 41. A protective insulating film 38 made of silicon nitride is formed covering the signal electrode, dot electrode and a portion of the gate insulating film.

As shown in FIG. 3, an ITO dot electrode (source electrode) 35 is formed on the protective insulating film 38, and electrically connected to the dot electrode (source electrode) wiring 48 made of metal (Cr/Mo) via a through hole 45 formed through the protective insulating film 38. As seen from FIG. 4, the ITO common electrode 33 is formed on the flat plane in one dot area as viewed in plan, and the ITO dot electrode (source electrode) 35 is formed in a comb shape slanted by about 7°. In this embodiment, a diagonal 32-inch active matrix substrate was used which was constituted of 1366×3 signal electrodes 36 and 768 scan electrodes 34.

Next, as shown in FIG. 5, a black matrix 44 was formed on a glass substrate 32 by using black resist manufactured by Tokyo Ohka Kogyo Co., Ltd., and by using commonly adopted photolithography involving the processes of coating, prebake, exposure, develop, rinse and postbake. In this embodiment, a film thickness was set to 1.5 μm. However, the film thickness is determined from the used black resist material in order to set an optical density to about 3 or higher. Next, color filters 42 were formed by using blue, green and red color resin, and by using commonly adopted photolithography involving the processes of coating, prebake, exposure, develop, rinse and postbake. In this embodiment, thicknesses of blue, green and red color filters were set to 3.0 μm, 2.8 μm and 2.7 μm, respectively. However, the thicknesses may be set properly to design values. The present invention is not limited only to the design values of the embodiment.

In this embodiment, although the color filters were formed by photolithography, the present invention is not limited to the photolithography. In short, the color filters may be formed by other methods such as an ink jet method, a printing method and a transfer method so long as these methods can control the spectral characteristics of the color filters.

For color filter pigment, C. I. Pigment Blue 15:6 and complementary color pigment C. I. Pigment Violet 23 were used for blue. C. I. Pigment Red 254 and complementary color pigment C. I. Pigment Yellow 139 were used for red. For green pigment, generally C. I. Pigment Green 36 (copper brome phthalocyanine green) or C. I. Pigment Green 7 (copper chloro phthalocyanine green) and complementary color pigment C. I. Pigment Yellow 150, C. I. Pigment Yellow 138 or the like are used. In this embodiment, the spectral characteristics can be controlled by adjusting the composition of pigment. By increasing the composition of complementary pigment slightly more than that of comparative examples, it is possible to set the half value wavelength on the longer wavelength side in a range from 590 nm to 600 nm. Although pigment is generally used nowadays, color filters may be made of dye if this coloring matter can control spectroscopy, and can ensure process stability and reliability.

Next, as shown in FIG. 2, an overcoat layer 43 made of V-259 manufactured by Nippon Steel Chemical Co., Ltd was formed for planarization and protection of the color filter layers. Exposure was performed by irradiating an i-line of a high pressure mercury lamp at a dose of 200 mJ/cm², and then heating was performed for 30 minutes at 200° C. A film thickness was about 1.2 to 1.5 μm above each dot. Next, as shown in FIG. 5, post spacers 47 having a height of about 3.8 μm were formed on the black matrix between respective blue dots, by using photosensitive resin and by using commonly adopted photolithography and etching. The position of the spot spacer is not limited to this embodiment, but the spot spacer may be disposed as desired when necessary. Instead of the post spacers, spherical ball spacers may be disposed at fixed points by a printing method, an ink jet method or the like.

Alignment films 22 and 23 made of a dense polyimide film of about 100 nm thick are formed on each of the TFT substrate and color filter substrate, by printing polyamic acid varnish thereon and performing heat treatment for 30 minutes at 210° C. The alignment films were subject to a rubbing process. The material of the alignment film of the embodiment is not particularly limited, but the material may be polyimide using 2,2-bis[4-(p-amino phenoxy) phenyl propane] as diamine, piromerit acid dianhydride as acid hydride, or polyimide using p-phenylene diamine, diaminodiphenyl methane or the like as an amine component, aliphatic tetra carbonic acid dianhydride, piromerit acid dianhydride as an acid anhydride component. Although the rubbing process is used in this embodiment, the process is not limited, but the alignment film may be formed by using photosensitive alignment film material and irradiating a polarized ultraviolet ray. An initial alignment state of liquid crystal, i.e., the alignment direction under no voltage application, was set to a direction of the scan electrode 34 shown in FIG. 4, i.e., the longer side direction of the substrate (in the case of the TFT substrate, a scan electrode direction).

Next, as shown in FIG. 2, a liquid crystal display panel for the liquid crystal display apparatus was assembled by disposing the two substrates, with the alignment films 22 and 23 having respective alignment abilities being faced each other, and coating the peripheral areas of the two substrates with sealing agent. Nematic liquid crystal mixture was injected into the panel, the nematic liquid crystal mixture having a dielectric constant anisotropy of +4.0 (at 1 KHz, 20° C.) and a reflectivity anisotropy of 0.10 (589 nm wavelength, 20° C.). In this embodiment, liquid crystal having a negative dielectric constant anisotropy may be used. In this case, the pixel electrode 35 is formed having a horizontal direction of 45° or larger relative to an electric field. An absorption axis of a polarizer 11 is set to the longer side direction of the liquid crystal display panel, and the absorption axis of a polarizer 12 was set perpendicular thereto. Thereafter, driver circuits, a light source unit and the like were connected to complete the liquid crystal display panel.

The structure in a region sandwitched between the substrates with the polarizers is called a liquid crystal display panel 13, and the structure in a region of the liquid crystal display panel and a light source unit 14 is called a liquid crystal display apparatus or a liquid crystal display module 15.

The liquid crystal display panel of the embodiment is characterized in the spectral transmittance characteristics of the color filters. FIG. 1 shows the spectral transmittance of the color filters of the embodiment. FIG. 1 shows the spectra of the blue color filter (hereinafter represented by B) having a high transmittance in a wavelength range from 450 to 500 nm, the green color filter (hereinafter represented by G) having a high transmittance in a wavelength range from 500 to 570 nm, and the red color filter (hereinafter represented by R) having a high transmittance in a wavelength range from 600 to 700 nm. In FIG. 1, a bold line corresponds to the spectrum of the green filter of the embodiment, and a fine line corresponds to the spectrum of a first comparative example to be detailed later.

As compared with the usually used filter (first comparative example), the green filter of the embodiment has a shape of the spectral waveform broadened toward the longer wavelength side. This spectrum waveform is represented by the wavelength at the half values as in the following.

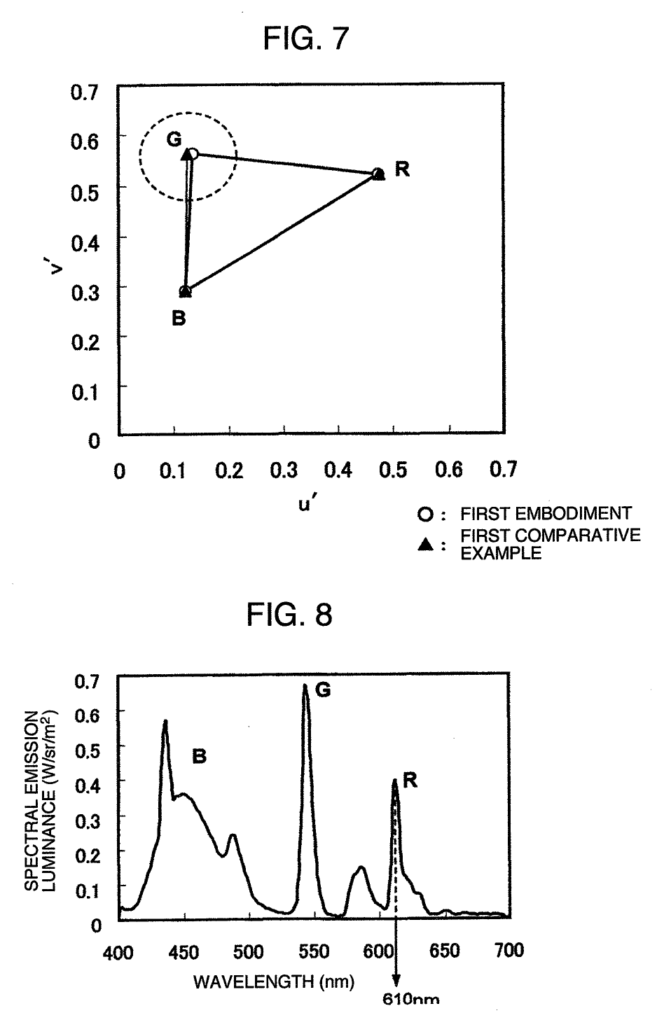

The green filter of the embodiment has the maximum transmittance of 82% at a wavelength of 530 nm (indicated by a broken line in FIG. 1). The wavelengths at half values of the maximum transmittance are 486 nm and 594 nm (indicated by a broken line and arrow lines). FIGS. 6 and 7 show the characteristics of the liquid crystal display panel having the wavelengths at the half values set as above.

In FIG. 6, black circles () indicate the spectral transmittance characteristics of white display of the liquid crystal display panel of the embodiment, and a solid line indicates the spectral transmittance characteristics of white display of the liquid crystal display panel of the first comparative example. A panel transmittance of white display of the embodiment was 5.9% and could improve the transmittance by 9% relative to the transmittance of the first comparative example described hereunder.

In FIG. 7, chromaticity coordinates of each color of the embodiment are represented by white circles (◯), and those of each color of the first comparative example to be described hereunder are represented by black triangles. As seen from FIG. 7, there are no changes in blue (B) and red (R), and blue and red have the same chromaticity coordinates for both the embodiment and first comparative example. The chromaticity coordinates of green (G) take values shifted inside relative to the first comparative example. This shift Δu′v′ is as very small as 0.008 so that this shift satisfies the condition (Δu′v′<0.02) not allowing visual perception of human being to detect. Namely, although the blue chromaticity of the embodiment is inferior to the first comparative example using the usual green filter, this inferiority is in a negligible range from the viewpoint of retaining color purity. FIG. 7 is a CIE 1976 u′v′ chromaticity diagram defined in a uniform color space.

It was confirmed from these results that the transmittance can be improved more than the conventional one and the color purity can be maintained in the range not influencing the visual perception characteristics, by utilizing the liquid crystal display panel structure of the embodiment. In order to realize both the improvement on the transmittance and the retention of the visual perception characteristics, the longer wavelength in the wavelengths at the half values of the maximum transmittance is set in the range from a minimum of 590 nm and a maximum of 610 nm in the spectral transmittance characteristics of the green color filter. In order to maintain the color purity higher, it is preferable to set in the range from a minimum of 590 nm to a maximum of 600 nm. The shorter wavelength in the wavelengths at the half values of the maximum transmittance is required to be set in the range from a minimum of 470 nm to a maximum of 500 nm, or more preferably in the range from a minimum of 480 nm to a maximum of 490 nm.

From another viewpoint, it is necessary that a transmittance at a wavelength of 600 nm of the green color filter is 40% or larger of the maximum transmittance.

### FIRST COMPARATIVE EXAMPLE

The fine line in FIG. 1 indicates the spectral characteristics of the green color filter used in the first comparative example. The spectral characteristics of the green filter show the maximum transmittance of 82% at a wavelength of 530 nm, and wavelengths of 485 nm and 582 nm at the half values of the maximum spectral transmittance. Only the half value wavelength on the longer wavelength side is greatly different from that of the first embodiment. The fine line in FIG. 6 indicates the spectrum of white display of the liquid crystal display panel of the first comparative example, and the black triangles in FIG. 7 indicate the chromaticity coordinates of each color. The panel transmittance of white display was 5.4%.

### Second Embodiment

In the second embodiment, a liquid crystal display module was manufactured by disposing a light source on the high transmittance liquid crystal display panel of the first embodiment. A cold cathode three-wavelength fluorescent lamp was used as the light source. For white display of the liquid crystal display module, the chromaticity of the back light unit was adjusted to obtain chromaticity coordinates u′v′ of (0.187, 0.437) by setting a color temperature to 11000 κ.

The fluorescent lamp of the back light unit of the second embodiment utilizes phosphors, BaMgAl₁₀O₁₇: Eu for blue, LaPO₄: Tb, Ce for green, and Y₂O₃: Eu for red, which are used generally in this field. The embodiment is not limited to these materials if the wavelength at the emission center does not differ greatly. For example, in the case of blue phosphor, one or several phosphors may be mixedly used if the emission center is in the wavelength range of 450±15 nm. In the case of green phosphor, if the emission center is terbium (Tb), the chromaticity can be adjusted in the manner similar to this embodiment, because the main peak is near at 545 nm and the sub peaks are near at 490 nm, 590 nm and 625 nm on both sides of the main peak, being influenced hardly by the composition of source materials. Phosphor having the emission center in the wavelength range of 610±5 nm may be used as the red phosphor.

The cold cathode tube is manufactured by a commonly adopted method. Namely, one side of a washed glass tube is immersed in suspension formed by mixing binding agent such as alumina and various phosphors in organic solvent, to coat phosphors on an inner wall of the glass tube through the capillary phenomenon. The material of the glass tube is, for example, kovar glass, a tube diameter is 4 mm and a tube length is 720 mm for a diagonal of 32 inches. These glass tubes are baked to adhere the phosphors to the inner tube wall. Thereafter, metal electrodes are mounted and one side of the glass tube is sealed. Rare gas such as argon and neon is injected into the glass tube from the side opposite to the sealed side, and degassed to adjust a gas pressure. Further, after mercury is filled and the glass tube is sealed and turned up side down to be subjected to an aging process for a predetermined time. The completed cold cathode tubes are disposed flat on a housing 19 whose inner side is covered with reflective agent. In this embodiment, fourteen glass tubes are disposed for a diagonal 32-inch module. An inverter is connected to the cold cathode tube to turn on the tube, or turn on/off for a blink back light to conduct luminance control through trimming in accordance with an average image luminance and an ambient environment illuminance. In this embodiment, although the cold cathode tube is used, the embodiment is not limited to the cold cathode tube. For example, a hot cathode fluorescent lamp may be used which has filaments as metal electrodes, or an external electrode fluorescent lamp (EEFL) may be used whose electrodes are disposed at opposite ends of the tube and wired outside the tube. A diffusion plate 18 is disposed above the cold cathode tube, and a luminance improving film 17 and a diffusion sheet 16 are disposed. FIG. 8 shows the spectrum of the back light unit formed in this manner. In FIG. 8, the abscissa represents a wavelength and the ordinate represents a spectral emission luminance. Emission peaks for red, green and blue are represented by R, G and B. Chromaticity coordinates are (0.195, 0.386), and a luminance is 8700 cd/m². A wavelength of the emission peak of red was 610 nm as indicated by a broken line and an arrow line in FIG. 8.

The back light unit was disposed on the back surface of the liquid crystal display panel of the first embodiment to form the liquid crystal display module. A color temperature of white display was 11000 κ as designed, a luminance was 503 cd/m², and a contrast ratio was 912. In order to compare with a second comparative example to be detailed hereunder, a white luminance of the liquid crystal display module was calculated through conversion of the luminance of the back light unit to 10000 cd/m², and the calculated value is 578 cd/m². Namely, if the back light has the same luminance, a luminance of the liquid crystal display module is improved by about 8% and the image quality is improved. Assuming that the while luminance of the liquid crystal display module is constant, a luminance of the back light necessary for obtaining a luminance of, e.g., 500 cd/m² is 8660 cd/m² which is improved by about 7%, resulting in a reduction in a consumption power. Whether the liquid crystal display of the embodiment is used as an improved luminance television or a reduced consumption power television is selected in accordance with needs.

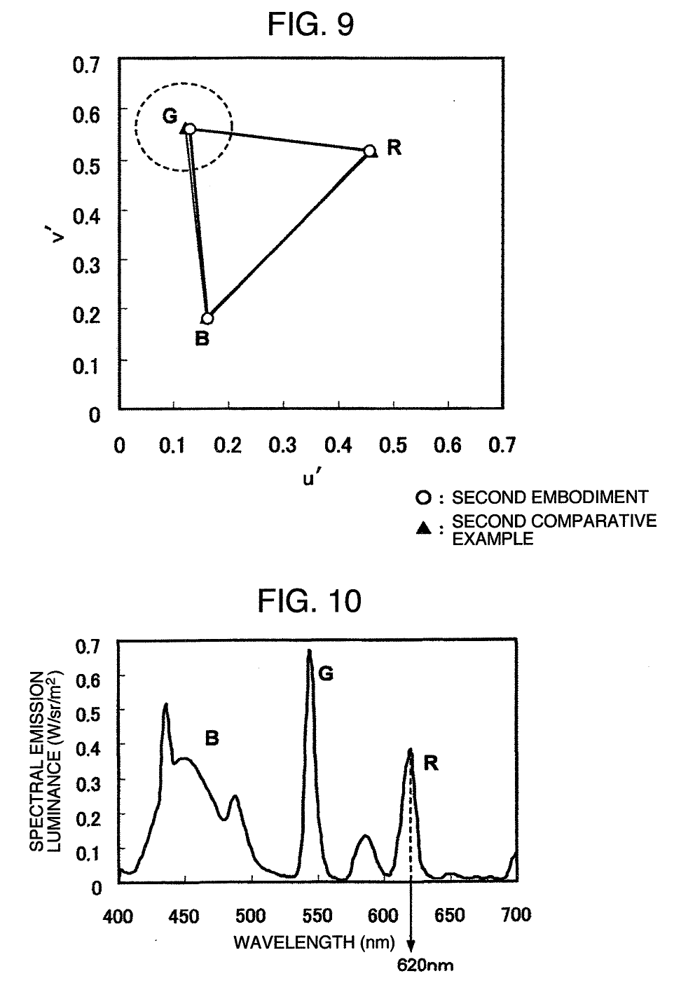

FIG. 9 shows chromaticity coordinates of each color of the liquid crystal display module of the embodiment. In FIG. 9, white circles (◯) correspond to the embodiment, and black triangles correspond to a second comparative example to be detailed hereunder. The liquid crystal display module of the embodiment has green chromaticity coordinates of (0.130, 0.560). Although the color purity is inferior to the second comparative example, a difference is as very small as Δu′v′=0.008 which is smaller than the detection limit of 0.02 by visual perception of human being. A chromaticity change between the embodiment and second comparative example did not pose a problem in visual evaluation.

It was confirmed from the above-described results that a module realizing both improving the transmittance and maintaining the visual perception characteristics more than a conventional case can be realized even when it is evaluated as a liquid crystal display module.

### SECOND COMPARATIVE EXAMPLE

In the second comparative example, a back light unit made of a cold cathode tube using phosphors similar to those of the first embodiment was mounted on the liquid crystal display panel of the first comparative example. In order to set white display of the liquid crystal display module to 11000 κ, the phosphor composition was adjusted to set the chromaticity coordinates of the back light unit to (0.197, 0.395), and a luminance of 8900 cd/m² was obtained for the back light unit.

A color temperature of white display of the liquid crystal display module of the comparative example was 11000 κ as designed, and a luminance was 477 cd/m². In order to compare with the embodiment, a white luminance of the liquid crystal display module calculated through conversion of the luminance of the back light unit to 10000 cd/m² is 536 cd/m². It was evidenced that superiority of the high transmittance liquid crystal display panel of the embodiment is retained also for the liquid crystal display module. The chromaticity coordinates of blue, green and red are indicated by black triangles in FIG. 9.

### Third Embodiment

This embodiment is similar to the second embodiment except that a red peak in the spectral emission luminance of a light source is shifted to the longer wavelength side. Red phosphor of YVO₄ : Eu is used for a cold cathode tube of the light source. FIG. 10 shows a spectrum of the spectral emission luminance of a back light unit of this embodiment. As indicated by a broken line and an arrow line in FIG. 10, a red peak wavelength of the luminance in the spectrum is set to 620 nm. The wavelength of 620 nm is a value shifted by 10 nm toward the longer wavelength side of 610 nm of the second embodiment (refer to FIG. 8).

Chromaticity coordinates of the back light of this embodiment were (0.195, 0.387) and a luminance was 8530 cd/m². The liquid crystal display panel of the first embodiment was used to assemble a liquid crystal display module. Evaluation of this liquid crystal display module showed that a color temperature of white display was 11000 κ and a corresponding luminance was 495 cd/m². A white luminance of the liquid crystal display module calculated through conversion of the luminance of the back light unit to 10000 cd/m² was 580 cd/m², and the luminance efficiency had the advantage equal to that of the second embodiment.

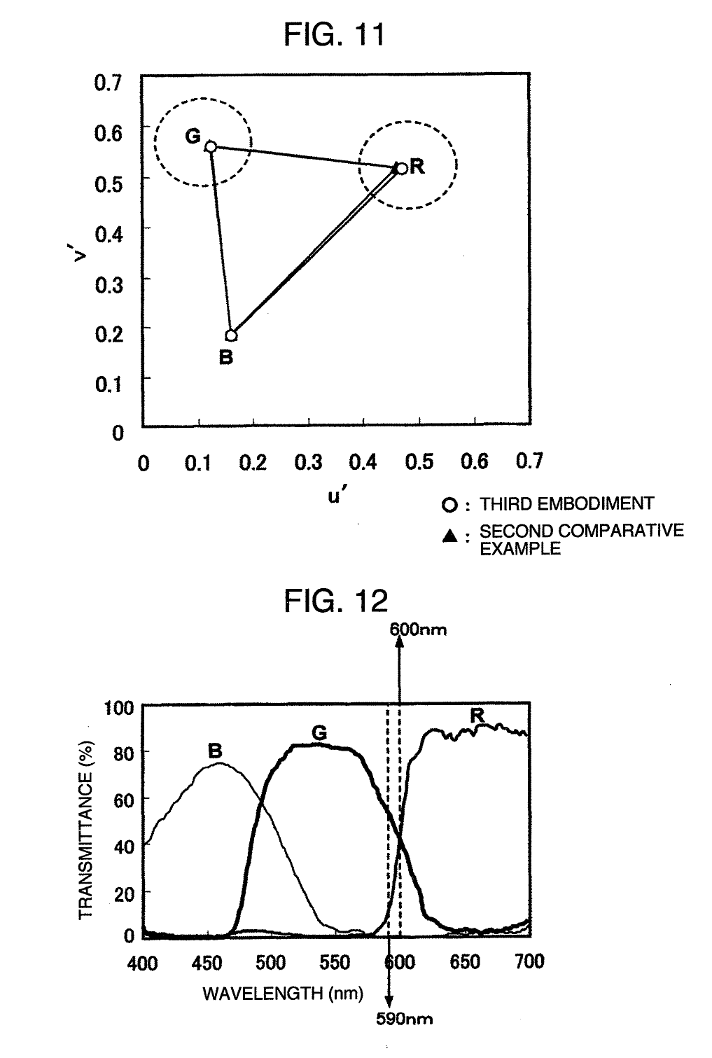

FIG. 11 shows chromaticity coordinates of the liquid crystal display module of the embodiment. In FIG. 11, white circles (◯) correspond to the embodiment, and black triangles correspond to the above-described second comparative example. The green chromaticity coordinates of the embodiment are (0.125, 0.560) which are generally equal to the green chromaticity coordinates (0.122, 0.562) of the second comparative example. This advantageous effect of this embodiment results from that a relative transmittance (a relative transmittance to the maximum spectral transmittance of a green filter) of the green filter is 7.3% at the red emission peak wavelength of 620 nm. Namely, the green filter of the embodiment has a transmittance increased toward the longer wavelength side in order to improve a transmission efficiency so that the relative transmittance at the emission wavelength of 611 nm of generally used red phosphor is 21%. If the transmittance of the green filter is high at the emission wavelength of red phosphor, a u′ chromaticity coordinate of green primary color display is increased and a tone of green primary color becomes slightly yellowish. In this embodiment, since phosphor having a red emission wavelength of 620 nm was used, it was possible to suppress an increase in the u′ chromaticity coordinate of green primary color display. In an actual television screen display, most of colors are displayed as colors in the natural world, and primary colors are hardly displayed. Green of the liquid crystal display module of the second embodiment poses therefore no problem. However, there is a case that it is important to conform with the chromaticity coordinates of the broadcasting specifications of the European Broadcasting Union (EBU). In this case, the liquid crystal display module of the third embodiment is suitable.

Red chromaticity coordinates are (0.470, 0.514). This means that a color purity is improved more than the chromaticity coordinates (0.460, 0.517) of the second comparative example. If the color purity of red is improved, it is said that red display for the natural world, for example, display of petals of a rose, can be made beautiful. The liquid crystal display module of the embodiment becomes more effective for the improvement on a display quality. Obviously, if a red emission wavelength is shifted more toward the longer wavelength side, a depth of red color increases more and more. However, in this case, in this wavelength range, a spectral luminous efficacy of human being lowers, and it is disadvantageous in terms of a luminance efficiency. For example, as seen from the spectral luminous efficacy characteristics shown in FIG. 18, a luminous spectral efficacy becomes smaller than 0.1 (a maximum spectral luminous efficacy is 1) at a wavelength in excess of a red emission wavelength of 650 nm. In contrast, a spectral luminous efficacy at a red emission wavelength of 620 nm is sufficiently as high as 0.38. Although a spectral luminous efficacy is 0.49 at an emission wavelength of 611 nm of commonly used red phosphor, the improvement of the luminance efficiency of the embodiment is generally equal to that of the second embodiment, and it can be understood that the spectral luminous efficacy at this level does not pose any problem. The liquid crystal display module of the embodiment realized an increase in the luminance efficiency, the retention of the color purity of blue and green and the improvement of a red color purity.

It has been found from these results that it is possible to improve the transmittance and the color purity, by broadening the range of the green color filter toward the longer wavelength side and shifting the peak wavelength of red of the light source toward the longer wavelength side.

When considering an efficiency and the like of phosphor, it is necessary to set the peak wavelength of red of the light source in a range from 620 nm to 650 nm. From the viewpoint of a transmittance of a color filter, it is necessary that the green color filter has a transmittance of 10% or lower of the maximum transmittance, at a peak wavelength of red of the light source.

### Fourth Embodiment

This embodiment is similar to the first embodiment except that a transmission range of a red filter among color filters is shifted to the longer wavelength side. FIG. 12 shows the spectral transmittance characteristics of color filters.

The maximum spectral transmittance of a green filter is 82.5% at a wavelength of 534 nm, and the relative transmittance is 46% at a wavelength of 600 nm. A red filter has a relative transmittance of 9.9% at a wavelength of 590 nm relative to the maximum transmittance (90.6% at a wavelength of 676 nm) of the red filter. As compared with the spectra shown in FIG. 1 of the first embodiment, it can be understood that the a rise of the transmittance of the red filter shifts toward the longer wavelength side. A transmittance of white display of the liquid crystal display panel of the embodiment was 5.92%.

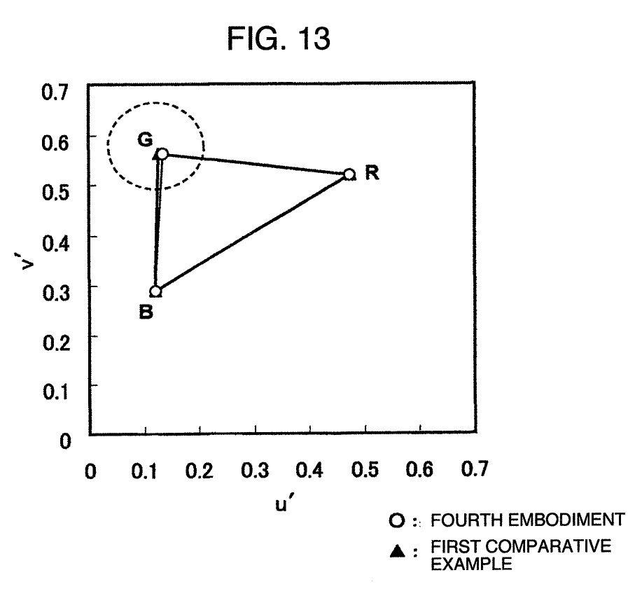

FIG. 13 shows chromaticity coordinates of the liquid crystal display panel of the embodiment. In FIG. 13, white circles (◯) correspond to the embodiment, and black triangles correspond to the above-described first comparative example. The chromaticity coordinates of green primary color have a difference of Δu′v′=0.009 from that of the first comparative example, which satisfies the condition that the difference is smaller than the detection limit (Δu′v′<0.02) of visual perception of human being. As compared to the visual characteristics of the first embodiment and first comparative example shown in FIG. 7, it can be understood that a shift of the chromaticity coordinates of green becomes small in FIG. 13. Namely, by shifting the transmission range of the red filter toward the longer wavelength side, it is possible to mitigate deterioration of the visual characteristics more than the first embodiment.

More specifically, it is necessary that the red color filter has a transmittance of 10% or lower of the maximum transmittance in a wavelength range from 580 nm to 590 nm.

### Fifth Embodiment

In the fifth embodiment, the liquid crystal display panel of the fourth embodiment is used with a back light unit using phosphors similar to those of the second embodiment to form a liquid crystal display module. In order to set white display of the liquid crystal display module to 11000 κ, the chromaticity coordinates of the back light unit were set to (0.194, 0.384) and the luminance was set to 8680 cd/m².

A luminance of white display of the liquid crystal display module was 503 cd/m². A luminance of white display of the liquid crystal display module calculated through conversion of the luminance of the back light unit to 10000 cd/m² is 586 cd/m², and the luminance efficiency has improved.

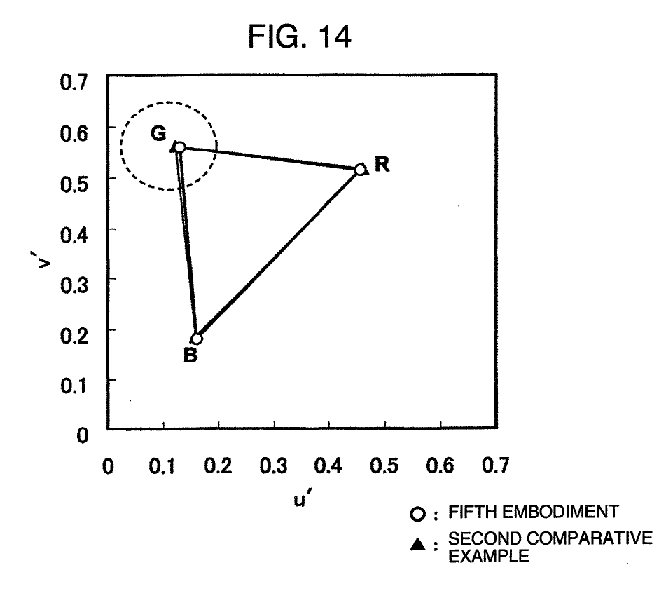

FIG. 14 shows the chromaticity coordinates (◯) of primary color display of blue, green and red together with the chromaticity coordinates of the second comparative example. The chromaticity coordinates of green primary color display have a difference of Δu′v′=0.008 from those of the second comparative example, which is sufficiently small. The luminance efficiency was able to be improved while the color purity is maintained.

### Sixth Embodiment

In the sixth embodiment, the liquid crystal display panel of the forth embodiment is used with a back light unit using red phosphor of YVO₄ : Eu similar to that of the third embodiment to form a liquid crystal display module.

The chromaticity coordinates of the back light unit were set to (0.194, 0.385) and the luminance was set to 8420 cd/m².

A luminance of white display of the liquid crystal display module was 504 cd/m². A luminance of white display of the liquid crystal display module calculated through conversion of the luminance of the back light unit to 10000 cd/m² is 588 cd/m², and the luminance efficiency has improved.

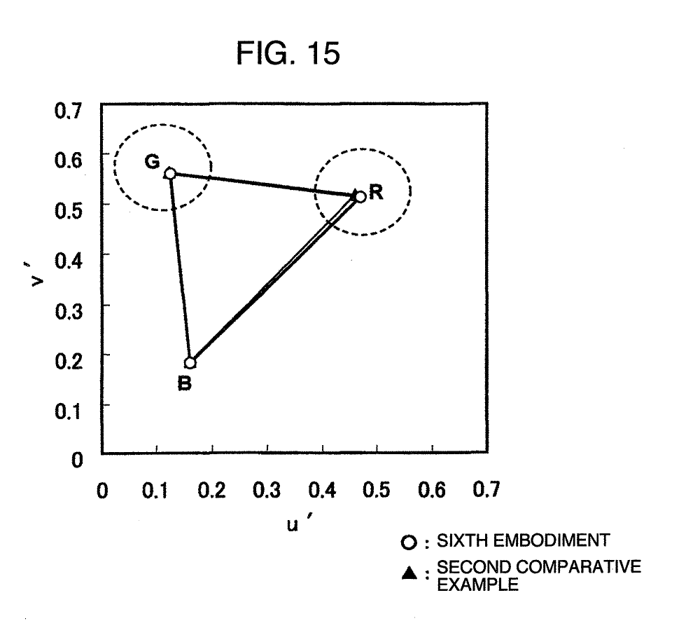

FIG. 15 shows the chromaticity coordinates (◯) of primary color display of blue, green and red together with the chromaticity coordinates of the second comparative example. The chromaticity coordinates of green primary color display have a difference of Δu′v′=0.003 from those of the second comparative example, which is sufficiently small. The chromaticity coordinates of red primary color display were (0.469, 0.513) and the color purity was able to be improved.

The light source of a back light unit is not limited to phosphors. For example, a light emitting diode, an organic EL or the like may be used, and the advantages similar to those of the present invention can be obtained by adjusting an emission wavelength. In short, the present invention is not limited to the type of a light source, and the important points to obtain the advantages of the present invention are as follows. For blue, an emission intensity is high in the wavelength range of 450 nm to 480 nm, or there is at least one emission peak in the range. For green, even a small emission exists in the range of 550 nm to 590 nm even if a main emission wavelength is near at 520 nm. For red, there is an emission at 611 nm or in a wavelength range of 620 nm to 650 nm.

### Seventh Embodiment

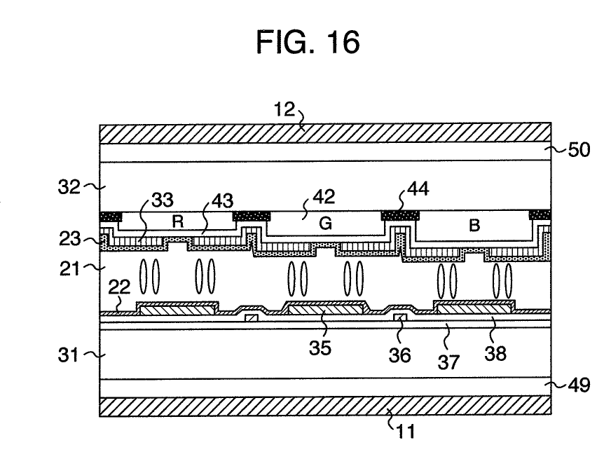

In this embodiment, a liquid crystal display module of a patterned vertical alignment (PVA) mode shown in FIG. 16 was manufactured.

An alkali-free glass substrate 32 having a thickness of 0.7 mm was used as a color filter substrate. A chrome film having a thickness of 160 nm and a chrome oxide film having a thickness of 40 nm were formed on the alkali-free glass substrate by continuous sputtering. A black matrix 44 was formed by coating positive type resist and performing processes of prebake, exposure, develop, etching, stripping and washing. Next, color filters 42 were formed by using color resist of blue, green and red, and by using commonly adopted photolithography involving the processes of coating, prebake, exposure, develop, rinse and postbake. In this embodiment, thicknesses of blue, green and red color filters were set to 3.0 μm, 2.7 μm and 2.5 μm, respectively. However, the thicknesses may be set properly according to a desired color purity or a liquid crystal layer thickness. The spectral characteristics are similar to those of the fourth embodiment.

An overcoat layer 43 made of V-259 manufactured by Nippon Steel Chemical Co., Ltd was formed. Exposure was performed by irradiating an i-line of a high pressure mercury lamp at a dose of 200 mJ/cm², and then heating was performed for 30 minutes at 200° C. A film thickness was about 1.2 to 1.5 μm above each dot. Although the overcoat layer was formed on the color filter layer, the overcoat layer may not be formed, but ITO may be formed directly by sputtering.

Next, ITO was deposited in vacuum by sputtering to a thickness of 140 nm, crystallized by heating ITO for 90 minutes at 240° C., and was subject to photolithography and etching to form a pattern of a common electrode 33. Openings of the common electrode 33 sandwich the opening of a dot electrode 35 at an intermediate position. Next, post spacers 47 having a height of about 3.5 μm were formed on the black matrix between respective blue dots, by using photosensitive resin and by using commonly adopted photolithography and etching.

An alkali-free glass substrate 31 having a thickness of 0.7 mm was used as an active matrix substrate. A scan electrode (gate electrode) 34 made of molybdenum/aluminum (Mo/Al) was formed on the substrate. In the same layer as that of the scan electrode, a holding capacitor electrode (not shown) may be formed by using chrome and aluminum. A gate insulating film 37 is formed covering these components, and a signal electrode (drain electrode) 36, and a thin film transistor (not shown) were formed similar to the first embodiment. A protective insulating film 38 is formed covering these components. Dot electrodes 35 made of ITO and having an opening pattern were formed on the protective insulating film. Transparent conductor such as indium zinc oxide (IZO) may be used. In this manner, an active matrix substrate (diagonal 32-inch size) having 1366×3×768 dots was obtained being constituted of 1366×3 (corresponding to R, G and B) signal electrodes 36 and 768 scan electrodes 34.

Alignment films 22 and 23 were formed on the TFT substrate and color filter substrate. Liquid crystal material having a negative dielectric constant anisotropy was dropped by one drop filling (ODF) method, and a liquid crystal display panel was assembled. A transmittance of white display of the liquid crystal display panel was 4.4%.

Phase plates 49 and 50 for compensating visual angle characteristics caused by liquid crystal molecule orientation were disposed between upper and lower polarizers 11 and 12 and the substrates 31 and 32. A drive circuit was connected to complete the liquid crystal display panel.

A back light unit is similar to that of the third embodiment except that a diffusion sheet and a luminance improving film are disposed on a diffusion plate. The liquid crystal display module was formed by using this back light unit. Chromaticity coordinates were set to (0.200, 0.422) in order to set white display of the liquid crystal display module to 11000 κ. A luminance on the surface of the back light unit was 8000 cd/m². Since the luminance improving film is used, a luminance of white display of the liquid crystal display module is improved by about 1.4 times.

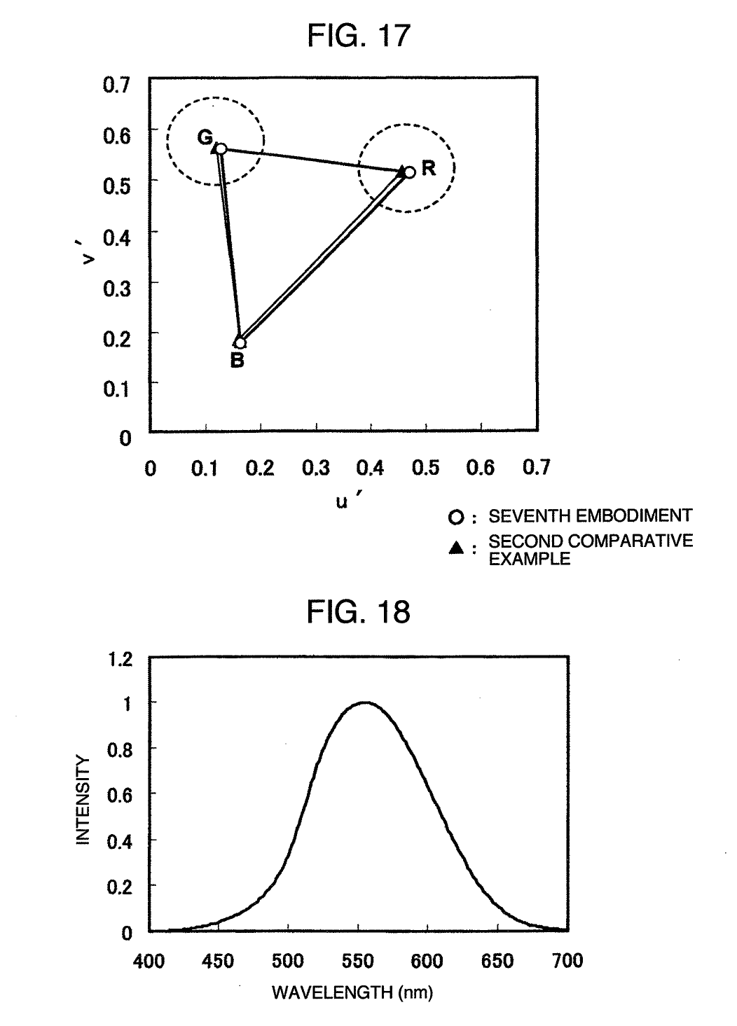

A luminance of white display of the liquid crystal display module is 486 cd/m² which can be understood that it is improved more than the following third comparative example. FIG. 17 shows chromaticity coordinates (◯) of blue, green and red primary color display together with chromaticity coordinates of the second comparative example. The chromaticity coordinates of green primary color display have a difference of Δu′v′=0.008 from the chromaticity coordinates of the second comparative example, and the difference is sufficiently small. The chromaticity coordinates of red primary color display were (0.471, 0.513), and the color purity was able to be improved.

In this embodiment, the liquid crystal display apparatus of a patterned vertical alignment (PVA) mode using an ITO notched pattern is used. If a multi domain vertical alignment (MVA) mode forming a projection on a color filter substrate is to be used, after ITO is formed, a projection forming process is executed and then the post spacer forming process is executed.

### THIRD COMPARATIVE EXAMPLE

A liquid crystal display module similar to the seventh embodiment was manufactured by using color filters similar to those of the first comparative example. Phosphors of the back light unit are similar to those of the second embodiment. The chromaticity coordinates were (0.204, 0.432) and a surface luminance was 8000 cd/m².

A color temperature of white display of the liquid crystal display module is 11000 κ and a luminance is 441 cd/m². The chromaticity coordinates of green primary color display were (0.121, 0.563), and the chromaticity coordinates of red primary color display were (0.458, 0.517).

The present invention is applicable to all types of liquid crystal display apparatus.

It should be further understood by those skilled in the art that although the foregoing description has been made on embodiments of the invention, the invention is not limited thereto and various changes and modifications may be made without departing from the spirit of the invention and the scope of the appended claims.

1. A liquid crystal display apparatus comprising:
a pair of substrates;
a pair of alignment plates disposed on said pair of substrates;
a liquid crystal layer confined between said pair of substrates;
an electrode group formed at least one of said pair of substrates, said electrode group applying an electric field to said liquid crystal layer;
color filters formed on one of said pair of substrates; and
a light source unit disposed on a back of the other of said pair of substrates,
wherein said color filters include at least blue, green and red color filters, and wavelengths providing halves of a maximum transmittance of said green color filter are between from 590 nm to 610 n on one side, and from 470 nm to 500 nm on the other side.

2. The liquid crystal display apparatus according to claim 1, wherein a wavelength providing half of said maximum transmittance of said green color filter lies in a range from 590 nm to 600 on one side.

3. The liquid crystal display apparatus according to claim 1, wherein said maximum transmittance of said green color filter is 80% or higher.

4. The liquid crystal display apparatus according to claim 1, wherein a wavelength providing said maximum transmittance of said green color filter lies in a range from 530 nm to 560 nm.

5. The liquid crystal display apparatus according to claim 1, wherein a light source of said light source unit has an emission peak wavelength from 620 nm to 650 nm in a wavelength range from 600 nm to 700 nm.

6. The liquid crystal display apparatus according to claim 1, wherein:
a light source of said light source unit has an emission peak in a wavelength range from 600 nm to 700 nm; and
a transmittance of said green color filter at a wavelength of said emission peak is 10% or smaller of said maximum transmittance.

7. The liquid crystal display apparatus according to claim 1, wherein a transmittance of said red color filter in a range from 580 nm to 590 nm is 10% or lower of a maximum transmittance.

8. A liquid crystal display apparatus comprising:
a pair of substrates;
a pair of alignment plates disposed on said pair of substrates;
a liquid crystal layer confined between said pair of substrates;
an electrode group formed at least one of said pair of substrates, said electrode group applying an electric field to said liquid crystal layer;
color filters formed on one of said pair of substrates; and
a light source unit disposed on a back of the other of said pair of substrates,
wherein said color filters include at least blue, green and red color filters, and a transmittance of said green filter at a wavelength of 600 nm is 40% or higher of a maximum transmittance.

9. The liquid crystal display apparatus according to claim 8, wherein a wavelength providing half of said maximum transmittance of said green color filter lies in a range from 590 nm to 600 nm on one side.

10. The liquid crystal display apparatus according to claim 8, wherein said maximum transmittance of said green color filter is 80% or higher.

11. The liquid crystal display apparatus according to claim 8, wherein a wavelength providing said maximum transmittance of said green color filter lies in a range from 530 nm to 560 nm.

12. The liquid crystal display apparatus according to claim 8, wherein a light source of said light source unit has an emission peak wavelength between from 620 nm to 650 nm in a wavelength range from 600 nm to 700 nm.

13. The liquid crystal display apparatus according to claim 8, wherein:
a light source of said light source unit has an emission peak in a wavelength range from 600 nm to 700 nm; and
a transmittance of said green color filter at a wavelength of said emission peak is 10% or smaller of said maximum transmittance.

14. The liquid crystal display apparatus according to claim 8, wherein a transmittance of said red color filter in a range from 580 nm to 590 nm is 10% or lower of a maximum transmittance.
